(19) United States
(12) Patent Application Publication
(10) Pub. No.: US 2005/0160144 A1
(43) Pub. Date: Jul. 21, 2005

(54) System and method for filtering network messages

(76) Inventor: Rishi Bhatia, (US)

Correspondence Address: JOSEPH W. SCHMIDT;Carter, DeLuca, Farrell & Schmidt, LLP, Suite 225, 445 Broad Hollow Road, Melville, NY, 11747, US

(21) Appl. No.: 10/745,851

(22) Filed: Dec. 24, 2003

(51) Int. Cl. G06F 15/16

(52) U.S. Cl. 709/206

(57) ABSTRACT

A system and method for filtering network messages, e.g., electronic mail, instant messages, etc. enables an administrator to control with whom other network users correspond, via a trusted list of network users or sources. The method includes the steps of determining an identity associated with a network message, comparing the identity with a predefined list of acceptable identities and transmitting the message if the identity matches an identity within the predefined list.

### BACKGROUND

1. Field

The present disclosure relates generally to data processing and communication systems, and more particularly, to a system and method for filtering network messages, e.g., electronic mail, instant messages, etc.

2. Description of the Related Art

In recent years, the availability of more efficient, reliable and cost-effective computers and networking tools has allowed many companies and individuals to become involved in an ever-growing electronic community. The immeasurable gains in technology experienced by the computer industry overall have allowed these users to rely on commercially available computers, such as personal computers (“PCs”), to meet their information processing and communication needs. To that end, PC manufacturers allow users to equip most PCs with an interface (such as a modem) that may be used for communication over networks, such as the Internet. The Internet is a well-known collection of networks (e.g., public and private voice, data, video and multimedia networks) that cooperate using common protocols to form a worldwide network of networks.

The combination of inexpensive personal computers and easy-to-use graphical software has enabled the Internet to become a major medium for communications among people around the world. Two extremely popular methods of communicating via the Internet, or any known network, are electronic mail, e.g., e-mail, and instant messaging, also known as IM.

E-mail is a method of sending and receiving electronic messages and files, over a computer network, e.g. the Internet. E-mail consists of a text message normally typed on a computer keyboard in an e-mail software application, for example an e-mail client such as Microsoft™ Outlook or Lotus™ Notes. Some e-mail software applications support HTML (Hypertext Markup Language) to let users incorporate formatted text and graphics within their e-mail messages. In addition to a text message, e-mail software applications also let users transmit computer files by attaching the file to the e-mail message. The availability of Web-based software is making e-mail even more accessible due to the fact Web-based e-mail is stored on a Web site that can be accessed from any computer with an Internet connection.

Instant messaging (“IM”) enables a user to send messages to another user that immediately appear on that user's computer screen over a network. Instant messaging can work on inter-office LANs (local-area networks) as well as the Internet. Instant messages are different from e-mail messages in that they do not sit unread until the user checks his or her e-mail; they appear on-screen as they are received in real time.

Various software applications with simple to use graphical user interfaces (GUI) have made these methods of communication available to those with little or no computer or programming skills, e.g., young children. Through unsolicited e-mails (e.g., spam), young children may be exposed to bulk messages that carry adult messages or images not appropriate for young viewers. Additionally, recent news stories have documented sexual predators luring young children and teens into dangerous situations after establishing relationships with these kids via instant messaging and/or chat rooms.

Currently, technology is available to stop spam, for example, spam filtering software. The simplest filters search keywords in the subject line or text of the e-mail to attempt to identify and delete spam. More advanced filtering software attempt to statistically identify spam based on word patterns or word frequency. However, the simple filters are easily fooled by simple spelling variations and the advanced filters can be worked around by adding random words to messages and by using short messages with no identifiable pattern. Additionally, the various filters end up blocking messages that the recipient actually wants.

Furthermore, technology is available to monitor user activity on a given computer. This technology can secretly monitor and record all key strokes generated on a computer, for example, in sending e-mail, chatting via instant messaging, etc. Besides the obvious privacy issues this technology raises, when used in a home computing environment, this monitoring technology breeds mistrust between parents and their children.

Therefore, a need exists for techniques to allow computer users to communicate freely in a trusted environment while protecting the user from unsolicited messages.

### SUMMARY

A system and method for filtering network messages, e.g., electronic mail, instant messages, etc. . . . are provided. The system and method of the present disclosure enable an administrator, e.g., a parent, to control with whom other network users, e.g., their kids, correspond via a trusted list of network users or sources; and the network users are free to communicate with the trusted sources. First, the administrator, e.g., a parent, will establish a trusted list of contacts or identities, for example, e-mail addresses, user names from buddy lists, etc., with which network users, e.g., their kids, can freely communicate. When a new network message arrives, e.g., e-mail or an instant message, a server will verify a sender's identity with the established trusted list. If the sender's identity is in the trusted list, the message will be forwarded to an intended recipient. If the message fails this filtration process, the message will be automatically forwarded to the administrator, e.g., a parent or if instructed by the administrator the message will be automatically deleted.

This filtration feature of the present disclosure will apply to incoming and outgoing e-mail messages, as well as to instant messaging. Accordingly, network users, e.g., a kid, can freely communicate with users in the trusted list without receiving unsolicited or predatory messages.

Generally stated, the present disclosure is directed to a method for filtering network messages for transmitting within a network. The method includes the steps of determining an identity associated with a network message, comparing the identity with a predefined list of acceptable identities and transmitting the message if the identity matches an identity within the predefined list. In one aspect, the network message is received from a network user and the identity of this network user is compared with the predefined list. The network message is then directed to an intended recipient upon confirmation of the user's identity. If the identity associated with the network message does not match an identity within the predetermined list, the network message is then directed to an unintended recipient e.g., an administrator or parent, or alternatively deleted.

In another aspect of the present disclosure, the network message is generated to be sent to an intended recipient. The identity of the recipient is compared with the predefined list of acceptable identities and forwarded to the intended recipient upon confirmation and acceptance of the identity. If the network message does not match an identity within the predetermined list, the network message is forwarded to an unintended recipient, e.g. an administrator or parent, or alternatively deleted.

The network message may be an electronic mail message or an instant message. The identifier or identity may be an e-mail address, an IP address or a user name. The network may be a local area network, a wide area network or the Internet.

In another aspect of the present disclosure, a program storage device is disclosed. The program storage device is readable by a machine, and tangibly embodies a program of instructions executable by the machine to perform any of the afore-mentioned method steps for filtering network messages.

In another aspect, a system for filtering network messages is disclosed. The system includes a receiver for receiving a network message, a comparator for comparing an identifier associated with the network message with a predetermined list of identifiers of network users and a transmitter for forwarding the network message to an intended recipient if the identifier matches an identifier of network users of the predetermined list.

### BRIEF DESCRIPTION OF THE DRAWINGS

The above and other aspects, features, and advantages of the present disclosure will become more apparent in light of the following detailed description when taken in conjunction with the accompanying drawings in which:

FIG. 1 is a block diagram of an exemplary system for filtering network messages in accordance with the principles of the present disclosure;

FIG. 2 is an exemplary computer for use in the system of FIG. 1; and

FIG. 3 is a flow chart illustrating a method for filtering network message in accordance with an embodiment of the present disclosure.

### DETAILED DESCRIPTION

Preferred embodiments of the present disclosure will be described hereinbelow with reference to the accompanying drawings. In the following description, well-known functions or constructions are not described in detail to avoid obscuring the disclosure in unnecessary detail.

A system and method for filtering network messages, e.g., electronic mail, instant messages, etc. are provided. The system and method of the present disclosure enable an administrator, e.g., a parent, to control with whom other network users, e.g., their kids, correspond with via a trusted list of network users or sources; and the network users are free to communicate whatever they like with the trusted sources.

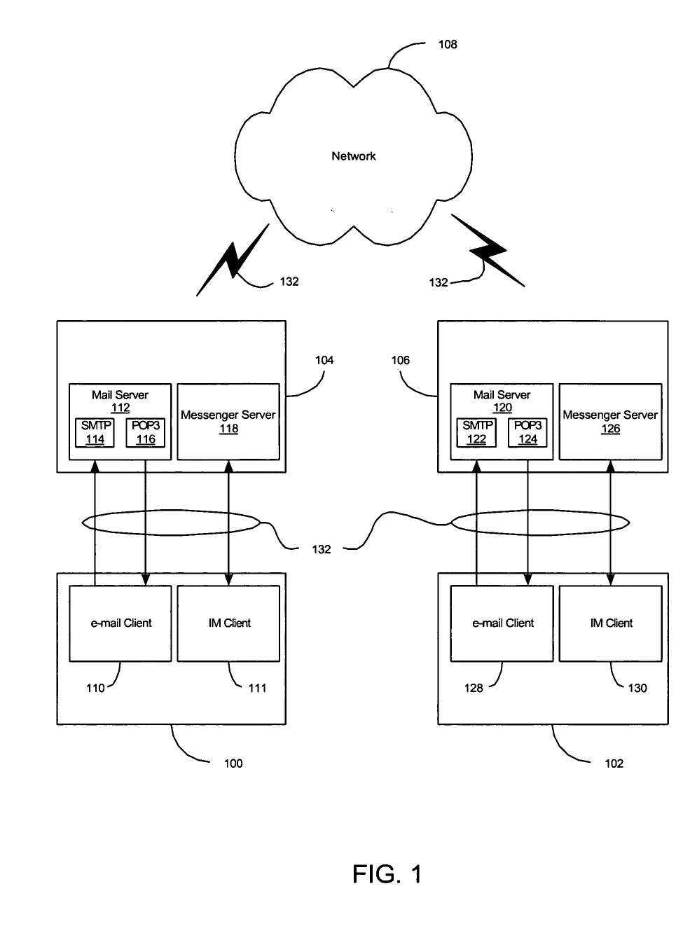

Referring to FIG. 1, an exemplary system for filtering network messages is illustrated. Generally, the system includes at least one computer 100, 102 for sending/receiving network messages. Each computer 100, 102 is coupled to at least one server 104, 106, e.g., an Internet Service Provider (ISP), for connecting the computers 102, 104 to a network 108, for example, the Internet.

Although the system of FIG. 1 is depicted with a plurality of computers 100, 102 communicating via ISPs over the Internet, it is to be appreciated that network 108 may be a local area network (LAN), wide area network (WAN) or any known network that couples a plurality of computers to enable various modes of communication via network messages. For example, the system may be a corporate intranet including a single server and multiple personal computers housed within a single facility, or alternatively, multiple servers with multiple personal computers located in various geographic locations.

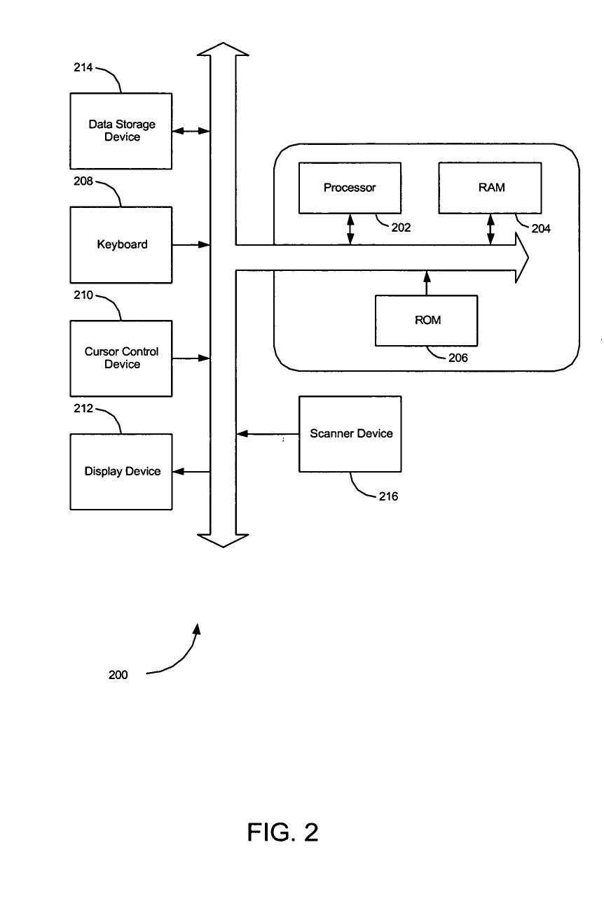

It is to be understood that the present disclosure may be implemented in various forms of hardware, software, firmware, special purpose processors, or a combination thereof. In one embodiment, the present disclosure may be implemented in software as an application program tangibly embodied on a program storage device. The application program may be uploaded to, and executed by, a machine including any suitable architecture such as personal computers 100, 102 or servers 104, 106. One suitable machine for executing these functions is illustrated in FIG. 2. Machine 200 is implemented on a computer platform having hardware such as one or more central processing units (CPU) 202, a random access memory (RAM) 204, a read only memory (ROM) 206 and input/output (I/O) interface(s) such as a keyboard 208, cursor control device 210 (e.g., a mouse or joystick) and display device 212. The computer platform also includes an operating system and micro instruction code. The various processes and functions described herein may either be part of the micro instruction code or part of the application program (or a combination thereof) which is executed via the operating system. In addition, various other peripheral devices may be connected to the computer platform such as an additional data storage device, a printing device and a scanning device 216.

It is to be further understood that, because some of the constituent system components and method steps depicted in the accompanying figures may be implemented in software, the actual connections between the system components (or the process steps) may differ depending upon the manner in which the present disclosure is programmed. Given the teachings of the present disclosure provided herein, one of ordinary skill in the related art will be able to contemplate these and similar implementations or configurations of the present disclosure.

Referring again to FIG. 1, the personal computers 100, 102 will include client software applications for enabling network communications, e.g., an e-mail client 110, 128 such as Microsoft™ Outlook. As a further example, the personal computers 100, 102 may include an instant messaging client 111, 130 such as AOL™ Instant Messenger (AIM), ICQ™, and MSN™ Messenger. The servers 104, 106 will be running the appropriate complimentary server application to the client application. For example, to execute e-mail, a mail server 112 will be provided including a Simple Mail Transfer Protocol (SMTP) server 114 for handling outgoing e-mail messages and a POP3 (Post Office Protocol version 3) server 116 for handling incoming e-mail messages. Likewise, when communicating via instant messaging, servers 104, 106 will execute the appropriate messenger server application 118, 126.

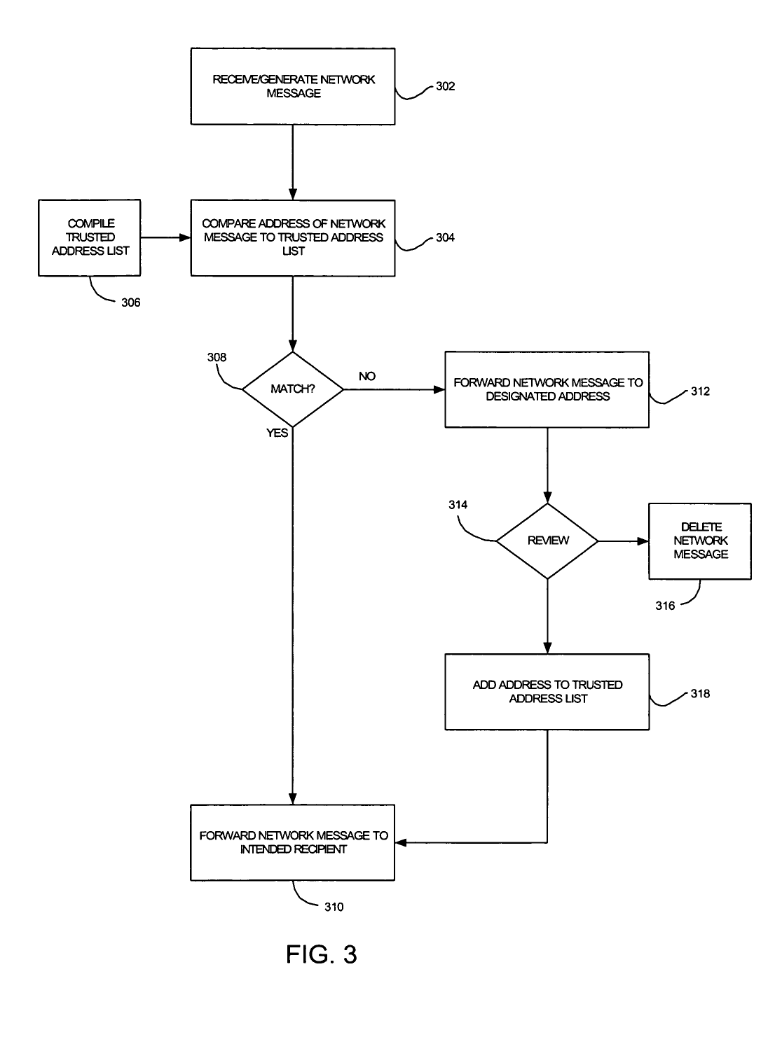

With reference to FIGS. 1 and 3, an embodiment of the present disclosure will be described in communicating through e-mail over the Internet. A first network user desires to send an e-mail to another network user, e.g. an intended recipient. The first network user opens an e-mail client 110 residing on personal computer 100. The first network creates a new e-mail by entering an e-mail address of the intended recipient and some text. Upon completion, the personal computer 100 sends the e-mail via SMTP to the mail server 112 of the ISP 104. The SMTP server 114 of ISP 104 then transfers the e-mail message via the Internet 108 to the SMTP server of the ISP 106 corresponding to the entered e-mail address. Once reached, the SMTP server 122 hands the message to the POP3 server 124 for delivery to the intended recipient.

It is to be understood that if the intended recipient had the same Internet Service Provider (ISP) 104 as the first network user, e.g., the sender, the e-mail would simply have been handed off from the SMTP server 114 to the POP3 server 116.

Once the server 106 has received the e-mail, e.g., the network message (step 302), the server 106 will compare the address of the sender of the e-mail (e.g., the sender's identity) to a trusted address list to determine if it is a valid address (step 304). It is to be understood that the server 106 may use any identifier (of the sender's identity) available to determine if the sender is on the trusted list. For example, the server may use the sender's e-mail address, e.g., johndoe@domain.com, or user name, or alternatively, may use the IP (Internet Protocol) address of the originating computer 100 which is sent along with the e-mail.

Preferably, an initial trusted address list is compiled before the recipient's computer 102 is activated (step 306). The trusted address list may be compiled by a network administrator responsible for protecting network users from spam and/or virus-laden e-mail. In a home computing environment, a parent may compile the trusted address list to allow only known sources to communicate with children of the household using the computer.

If the sender's identifier matches an identifier on the trusted address list (step 308), the e-mail will be placed or transmitted in the intended recipient's mailbox on the POP3 server 124 awaiting to be transferred to the recipient's e-mail client 128 (step 310). In this situation, the system administrator never sees the e-mail since it originated from a trusted source.

However, if the sender's identifier does not matches an identifier on the trusted address list (step 308), the e-mail will be placed in a designated mailbox on the POP3 server 124 awaiting to be transferred to the e-mail client 128 (step 312). Preferably, the designated mailbox will be of the system administrator, or in the home computing environment, of the parent. Upon activating the e-mail client 128, the administrator may review the e-mail message (step 314) for content. Upon review, the administrator may simply delete the network message, e.g., e-mail (step 316). Alternatively, upon review, the administrator may determine that the e-mail source is friendly and/or has not yet been added to the trusted list. If the e-mail meets the approval of the administrator, the administrator may add the sender's e-mail address to the trusted address list (step 318) and the email will subsequently be forwarded to the intended recipient's mailbox (step 310). As a further alternative, if the sender's identifier does not matches an identifier on the trusted address list (step 308), the e-mail may simply just be deleted, as in the case when receiving a large amount of unsolicited mail, e.g., spam.

Similarly, the method of the present disclosure will perform the filtering process described above in relation to outgoing messages. For example, the network user of computer 102 may generate an e-mail message and enter an e-mail address that they saw in an advertisement or received verbally from an unknown source. The e-mail client 128 will send the e-mail to the mail server 120 via SMTP (step 302). Before transferring the e-mail to a SMTP server of the newly entered e-mail, the server 106 will then compare the address of the newly entered e-mail to a trusted address list to determine if it is a valid address (step 304). If the newly entered address's identifier matches an identifier on the trusted address list (step 308), the e-mail will be forwarded to the intended mail server related to the newly entered address via the suitable network connection, e.g., the Internet (step 310). However, if it does not match, the e-mail will be handed over to the POP3 server 124 and placed in the administrator's mailbox for deletion or review as described above in relation to steps 312 through 318.

It is to be appreciated that although the above described embodiment performs the filtering method at the server level, for example, at the mail server, the filtering method may be performed by a client software application executed on the personal computer level 100, 102 and running as a background application. For an incoming network message, the background application will perform the filtering method after the message is received in the personal computer from the POP3 server but before the e-mail message is placed in the “inbox” of the e-mail client. Likewise, for an outgoing message, the background application will perform the filtering method before sending the e-mail to the SMTP server. For example, if an e-mail is sent to an address not on the trusted address list, the e-mail will be sent from personal computers 102 to the SMTP server 122 addressed to the administrator and immediately handed over to the POP3 server 124 to be delivered to the administrator. In this embodiment, the background application will be password protected so only the administrator may add/delete/edit the trusted address list.

It is to be appreciated that computer 100, 102 may be any computing device capable of sending and receiving network messages, for example, a laptop/notebook computer, a mobile telephone, a personal digital assistant (PDA) such as a Pocket PC™, Palm™, etc. Furthermore, the computing devices 100, 102 may communicate to the servers 104, 106 and network 108 via any known communication link 132, for example, dial-up, hardwired, cable, DSL, satellite, cellular, PCS, wireless transmission (e.g., 802.11a/b/g), etc.

While the disclosure has been shown and described with reference to certain preferred embodiments thereof, it will be understood by those skilled in the art that various changes in form and detail may be made therein without departing from the spirit and scope of the disclosure as defined by the appended claims.

What is claimed is:

1. A method for filtering network messages for transmitting within a network of a computer system comprising:
determining an identity associated with a network message;
comparing the identity with a predefined list of acceptable identities; and
transmitting the message if the identity matches an identity within the predefined list.

2. The method according to claim 1 further including the step of receiving the network message from a network user.

3. The method according to claim 2 wherein the step of comparing includes comparing the identity of the network user with the predefined list of acceptable identities.

4. The method according to claim 3 wherein the step of transmitting includes directing the network message to an intended recipient.

5. The method according to claim 3 further including the step of directing the network message to an unintended recipient if the identity associated with the network message does not match an identity within the predetermined list.

6. The method according to claim 3 further including the step of deleting the network message if the identity associated with the network message does not match an identity within the predetermined list.

7. The method according to claim 1 further including the step of generating the network message.

8. The method according to claim 7 wherein the step of transmitting includes sending the network message to an intended recipient.

9. The method according to claim 7 further including the step of forwarding the network message to an unintended recipient if the identity associated with the network message does not match an identity within the predetermined list.

10. The method according to claim 7 further including the step of deleting the network message if the identity associated with the network message does not match an identity within the predetermined list.

11. The method according to claim 1 wherein the network message is one of an electronic mail message and an instant message.

12. The method according to claim 1 wherein the identifier is one of an e-mail address, an IP address and a user name.

13. The method according to claim 1 wherein the network is selected from the group consisting of a local area network, a wide area network or the Internet.

14. A program storage device readable by a machine, tangibly embodying a program of instructions executable by the machine to perform method steps for filtering network messages, the method steps comprising:
determining an identity associated with a network message;
comparing the identity with a predefined list of acceptable identities; and
transmitting the message if the identity matches an identity within the predefined list.

15. A system for filtering network messages, the system comprising:
a receiver for receiving a network message;
a comparator for comparing an identifier associated with the network message with a predetermined list of identifiers of network users; and
a transmitter for forwarding the network message to an intended recipient if the identifier of the first network user matches an identifier of network users of the predetermined list

16. A system for filtering network messages for transmitting within a network of a computer system, comprising:
means for determining an identity associated with a network message;
means for comparing the identity with a predefined list of acceptable identities; and
means for transmitting the message if the identity matches an identity within the predefined list.
